(19) United States
(12) Patent Application Publication
(10) Pub. No.: US 2018/0098531 A1
(43) Pub. Date: Apr. 12, 2018

(54) Trotline Organizing and Storage Device

(71) Applicant: Paul Henderson, Lexington, OK (US)

(72) Inventor: Paul Henderson, Lexington, OK (US)

(21) Appl. No.: 15/287,999

(22) Filed: Oct. 7, 2016

(51) Int. Cl. A01K 91/18; A01K 97/06

(52) U.S. Cl. CPC A01K 91/18; A01K 97/06

(57) ABSTRACT

A trotline organizing and storage device includes a tube having a first end, which is closed, and a second end, which is open. A slot, positioned in a wall of the tube, extends from the second end to proximate to the first end. A rod is coupled to the first end and extends axially through the tube to proximate to the second end. The rod configured to position a fishhook of a trotline around the rod. Adjacent fishhooks of the trotline then are sequentially positionable upon the rod until all of the fishhooks are stowed within the tube. The shanks of the fishhooks are positioned through the slot such that line attached to eyes of the fishhooks is positioned outside of the tube. A cover is configured to reversibly couple to the second end to retain the fishhooks within the tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to organizing and storage devices and more particularly pertains to a new organizing and storage device for trotlines.

### BRIEF SUMMARY OF THE INVENTION

An embodiment of the disclosure meets the needs presented above by generally comprising a tube having a first end, which is closed, and a second end, which is open. A slot, positioned in a wall of the tube, extends from the second end to proximate to the first end. A rod is coupled to the first end and extends axially through the tube to proximate to the second end. The rod configured to position a fishhook of a trotline around the rod. Adjacent fishhooks of the trotline then are sequentially positionable upon the rod until all of the fishhooks are stowed within the tube. The shanks of the fishhooks are positioned through the slot such that line attached to eyes of the fishhooks is positioned outside of the tube. A cover is configured to reversibly couple to the second end to retain the fishhooks within the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a trotline organizing and storage device according to an embodiment of the disclosure.

FIG. 2 is an isometric perspective view of an embodiment of the disclosure.

FIG. 3 is a cut-away view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

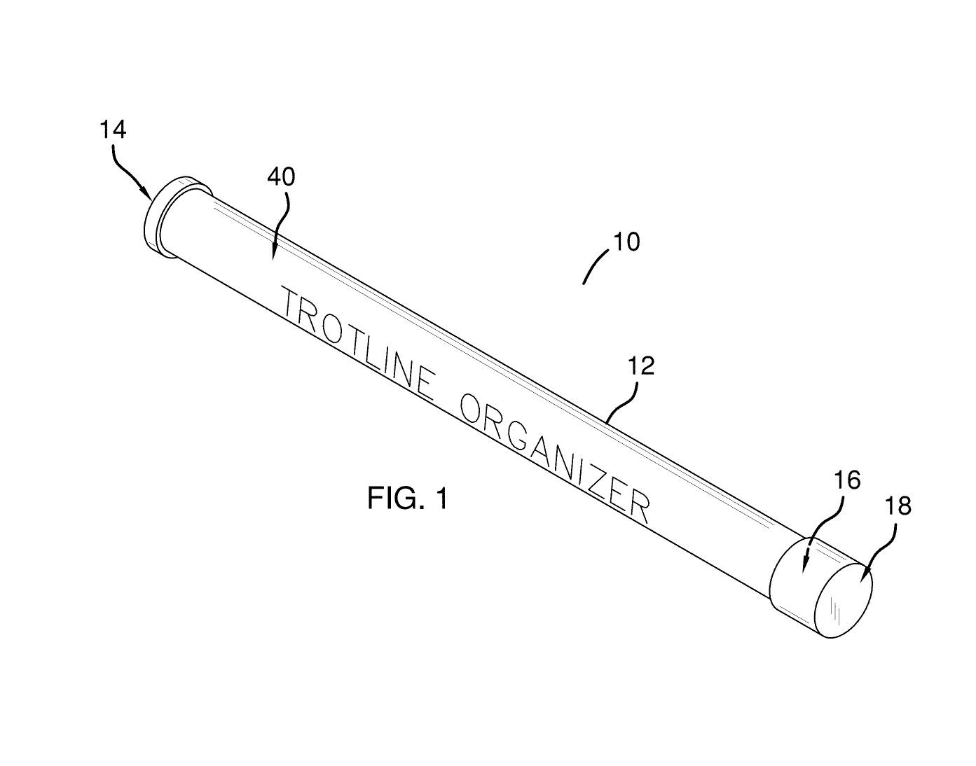

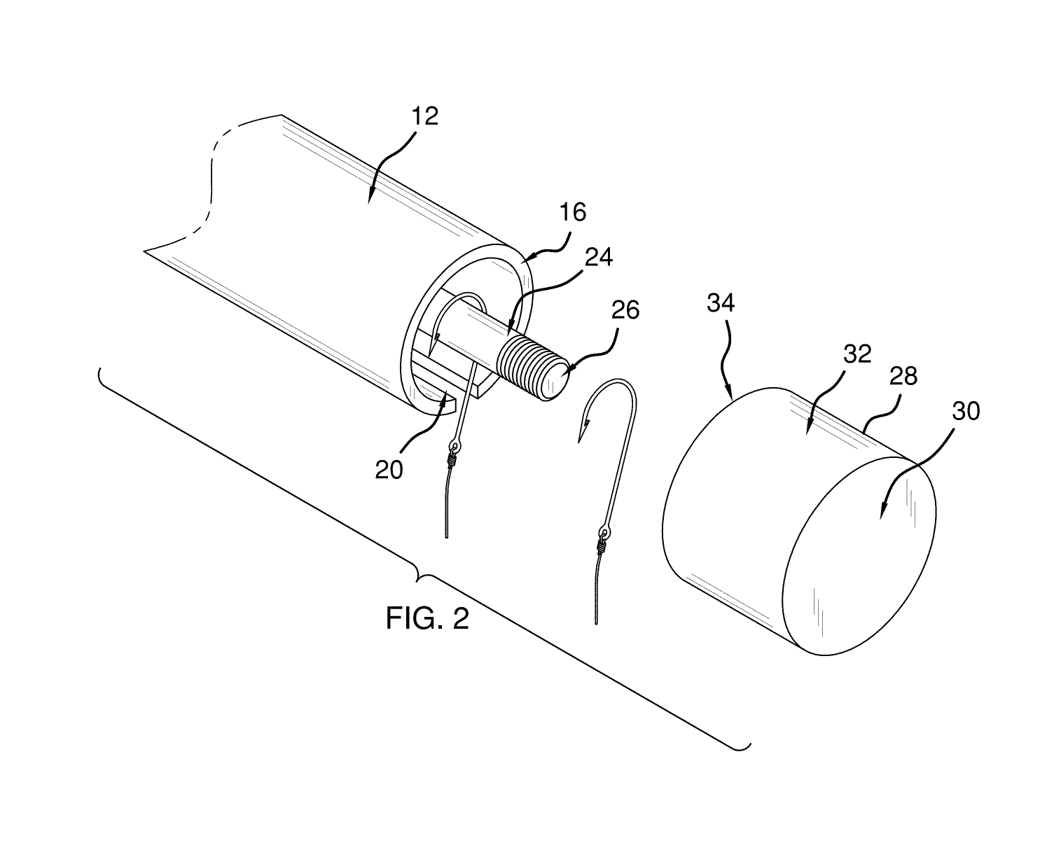

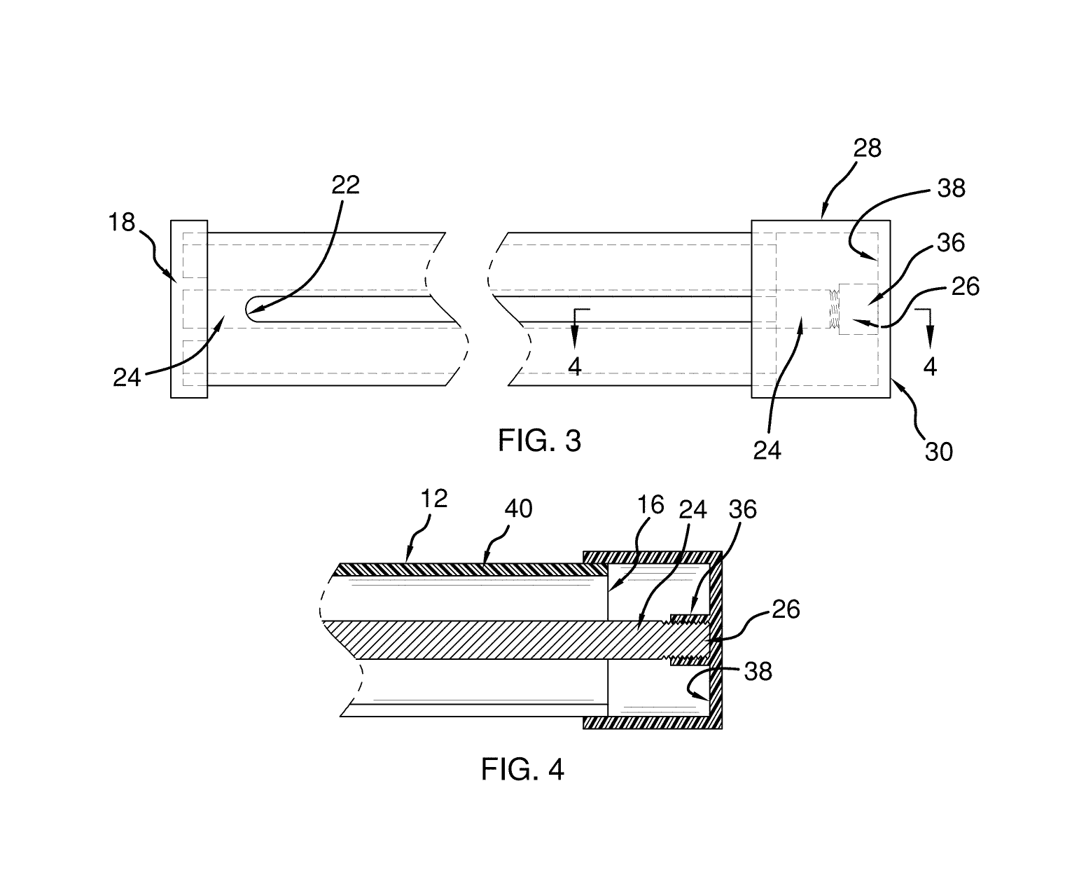

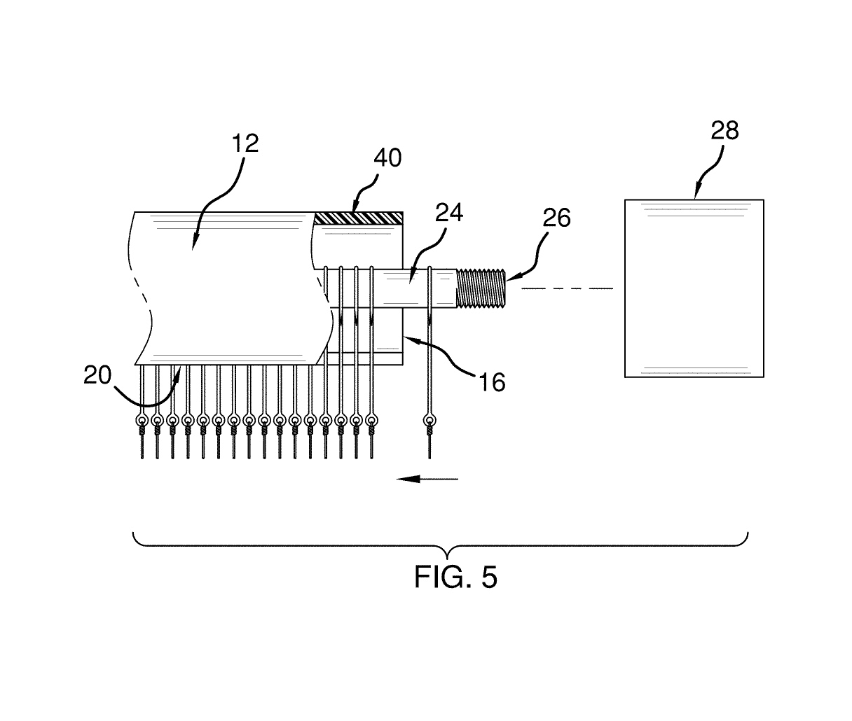

With reference now to the drawings, and in particular to FIGS. 1 through 5 thereof, a new organizing and storage device embodying the principles and concepts of an embodiment of the disclosure and generally designated by the reference numeral 10 will be described.

As best illustrated in FIGS. 1 through 5, the trotline organizing and storage device 10 generally comprises a tube 12 that has a first end 14 and a second end 16. The first end 14 is closed and the second end 16 is open. In one embodiment, the first end 14 comprises a cap 18 that is fixedly coupled to the tube 12. In another embodiment, the tube 12 is circular when viewed longitudinally.

A slot 20 is positioned in a wall 40 of the tube 12. The slot 20 extends from the second end 16 to proximate to the first end 14. The slot 20 has a terminus 22 that is positioned proximate to the first end 14. In one embodiment, the terminus 22 is arcuate.

A rod 24 is coupled to the first end 14. The rod 24 extends axially through the tube 12 to proximate to the second end 16 and defines a free end 26 of the rod 24. The rod 24 is positioned in the tube 12 such that the free end 26 is configured to position a fishhook of a trotline around the rod 24, with a shank of the fishhook positioned through the slot 20. Adjacent fishhooks of the trotline then are sequentially positionable upon the rod 24 until all of the fishhooks of the trotline are stowed within the tube 12. The shanks of the fishhooks are positioned through the slot 20 such that line attached to eyes of the fishhooks is positioned outside of the tube 12.

In one embodiment, the rod 24 is circular when viewed longitudinally. In another embodiment, the free end 26 of the rod 24 protrudes through the second end 16 of the tube 12. The free end 26 is threaded.

The device 10 comprises a cover 28 that is complementary to the second end 16. The cover 28 is configured to reversibly couple to the tube 12. The cover 28 is positioned to couple to the tube 12 to close the second end 16 to retain the fishhooks within the tube 12.

In one embodiment, the cover 28 comprises a top 30, which is closed. An annular sidewall 32 is coupled to and extends from the top 30 to a bottom 34, which is open. The bottom 34 is complementary to the second end 16 of the tube 12. The bottom 34 is positioned to insert the second end 16 of the tube 12 into the cover 28, wherein the second end 16 is closed.

In another embodiment, a nut 36 is coupled to an inside surface 38 of the top 30. The nut 36 is threaded and complementary to the free end 26 of the rod 24. The nut 36 is positioned on the top 30 such that the nut 36 is positioned to threadedly couple to the free end 26 of the rod 24 to couple the cover 28 to the tube 12.

In one embodiment, the tube 12, the rod 24 and the cover 28 comprise plastic. In another embodiment, the tube 12, the rod 24 and the cover 28 comprise polyvinylchloride. In yet another embodiment, the tube 12, the rod 24 and the cover 28 comprise metal. In still yet another embodiment, the tube 12, the rod 24 and the cover 28 comprise copper.

In use, the rod 24 is positioned in the tube 12 such that the free end 26 is configured to position a fishhook of a trotline around the rod 24, with a shank of the fishhook positioned through the slot 20. Adjacent fishhooks of the trotline then are sequentially positionable upon the rod 24 until all of the fishhooks of the trotline are stowed within the tube 12. The shanks of the fishhooks are positioned through the slot 20 such that the line attached to the eyes of the fishhooks is positioned outside of the tube 12. The nut 36 is positioned to threadedly couple to the free end 26 of the rod 24 to couple the cover 28 to the tube 12. The second end 16 is closed to retain the fishhooks within the tube 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trotline organizing and storage device comprising:
a tube having a first end and a second end, said first end being closed, said second end being open;
a slot positioned in a wall of said tube, said slot extending from said second end to proximate to said first end;
a rod coupled to said first end, said rod extending axially through said tube to proximate to said second end defining a free end of said rod;
a cover complementary to said second end, said cover being configured for reversibly coupling to said tube; and
wherein said rod is positioned in said tube such that said free end is configured for positioning of a fishhook of a trotline around said rod with a shank of the fishhook positioned through said slot, wherein adjacent fishhooks of the trotline then are sequentially positionable upon said rod such that all of the fishhooks of the trotline are stowed within said tube, wherein the shanks of the fishhooks are positioned through said slot such that line attached to eyes of the fishhooks is positioned outside of said tube, wherein said cover is positioned to couple to said tube to close said second end to retain the fishhooks within said tube.

2. The device of claim 1, further including said first end comprising a cap fixedly coupled to said tube.

3. The device of claim 1, further including said tube being circular when viewed longitudinally.

4. The device of claim 1, further including said tube, said rod and said cover comprising plastic.

5. The device of claim 4, further including said tube, said rod and said cover comprising polyvinylchloride.

6. The device of claim 1, further including said tube, said rod and said cover comprising metal.

7. The device of claim 6, further including said tube, said rod and said cover comprising copper.

8. The device of claim 1, further including said slot having a terminus positioned proximate to said first end, said terminus being arcuate.

9. The device of claim 1, further including said rod being circular when viewed longitudinally.

10. The device of claim 1, further including said cover comprising:
a top, said top being closed;
an annular sidewall coupled to and extending from said top to a bottom, said bottom being open, said bottom being complementary to said second end of said tube; and
wherein said bottom is positioned for insertion of said second end of said tube into said cover, such that said second end is closed.

11. The device of claim 10, further comprising:
said free end of said rod protruding through said second end of said tube, said free end being threaded;
a nut coupled to an inside surface of said top, said nut being threaded, said nut being complementary to said free end of said rod; and
wherein said nut is positioned on said top such that said nut is positioned to threadedly couple to said free end of said rod to couple said cover to said tube.

12. A trotline organizing and storage device comprising:
a tube having a first end and a second end, said first end being closed, said second end being open, said first end comprising a cap fixedly coupled to said tube, said tube being circular when viewed longitudinally;
a slot positioned in a wall of said tube, said slot extending from said second end to proximate to said first end, said slot having a terminus positioned proximate to said first end, said terminus being arcuate;
a rod coupled to said first end, said rod extending axially through said tube to proximate to said second end defining a free end of said rod, wherein said rod is positioned in said tube such that said free end is configured for positioning of a fishhook of a trotline around said rod with a shank of the fishhook positioned through said slot, wherein adjacent fishhooks of the trotline then are sequentially positionable upon said rod such that all of the fishhooks of the trotline are stowed within said tube, wherein the shanks of the fishhooks are positioned through said slot such that line attached to eyes of the fishhooks is positioned outside of said tube, said rod being circular when viewed longitudinally, said free end of said rod protruding through said second end of said tube, said free end being threaded;
a cover complementary to said second end, said cover being configured for reversibly coupling to said tube, wherein said cover is positioned to couple to said tube to close said second end to retain the fishhooks within said tube, said cover comprising:
a top, said top being closed,
an annular sidewall coupled to and extending from said top to a bottom, said bottom being open, said bottom being complementary to said second end of said tube, and
wherein said bottom is positioned for insertion of said second end of said tube into said cover, such that said second end is closed;
a nut coupled to an inside surface of said top, said nut being threaded, said nut being complementary to said free end of said rod, wherein said nut is positioned on said top such that said nut is positioned to threadedly couple to said free end of said rod to couple said cover to said tube;
said tube, said rod and said cover comprising plastic, said tube, said rod and said cover comprising polyvinylchloride, said tube, said rod and said cover comprising metal, said tube, said rod and said cover comprising copper; and
wherein said rod is positioned in said tube such that said free end is configured for positioning of a fishhook of a trotline around said rod with a shank of the fishhook positioned through said slot, wherein adjacent fishhooks of the trotline then are sequentially positionable upon said rod such that all of the fishhooks of the trotline are stowed within said tube, wherein the shanks of the fishhooks are positioned through said slot such that line attached to the eyes of the fishhooks is positioned outside of said tube, wherein said nut is positioned on said top such that said nut is positioned to threadedly couple to said free end of said rod to couple said cover to said tube, such that said second end is closed to retain the fishhooks within said tube.
